(19) United States
(12) Patent Application Publication
(10) Pub. No.: US 2025/0086779 A1
(43) Pub. Date: Mar. 13, 2025

(54) INFORMATION PROCESSING APPARATUS AND INFORMATION PROCESSING METHOD

(71) Applicant: KABUSHIKI KAISHA TOSHIBA, Tokyo (JP)

(72) Inventor: Hideo NISHIUCHI, Yokohama (JP)

(73) Assignee: KABUSHIKI KAISHA TOSHIBA, Tokyo (JP)

(21) Appl. No.: 18/604,855

(22) Filed: Mar. 14, 2024

(30) Foreign Application Priority Data
Sep. 13, 2023 (JP) 2023-148668

(51) Int. Cl. G06T 7/00; G06T 7/13; G06T 11/00

(52) U.S. Cl. CPC G06T 7/0006; G06T 7/001; G06T 7/13; G06T 11/001; G06T 2207/10024; G06T 2207/20081; G06T 2207/30141

(57) ABSTRACT

In an embodiment, an information processing apparatus includes an image generation unit and a determination unit. The image generation unit generates input image data showing a pre-reflow state based on soldering-related design information, and applies a color or a pattern corresponding to color information set for each of a plurality of types of components, in the input image data, to each of the plurality of types of components. The determination unit determines appropriateness of a design shown in the design information by inputting, to a machine learning model outputting an inspection result of a post-reflow inspection in response to inputting of image data based on a pre-reflow image, the input image data.

### CROSS-REFERENCE TO RELATED APPLICATION

This application is based upon and claims the benefit of priority from Japanese Patent Application No. 2023-148668, filed Sep. 13, 2023; the entire contents of which are incorporated herein by reference.

### FIELD

Embodiments described herein relate generally to an information processing apparatus and an information processing method.

### BACKGROUND

In joining a part to a substrate such as a board by means of soldering, room-temperature solder and the part are mounted in this order onto the substrate. By performing a reflow process with the solder and the part mounted on the substrate, the solder is melted, allowing the part to be joined to the substrate by means of soldering. After printed boards, etc., are manufactured as products by joining a part onto a substrate such as a board by means of soldering, inspection such as a visual inspection and an electrical test are performed on the manufactured products after the reflow process, to prevent defective products from being distributed to the market.

In the case of manufacturing products by means of soldering, as described above, soldering-related designs are carried out before mounting of solder and a part onto a substrate. In the soldering-related designs, a design regarding a substrate such as a board, a design for a metal mask used in mounting of solder onto the substrate, and a design regarding a part, for example, are carried out. In manufacturing of products by means of soldering, at a design stage prior to start of the manufacturing, it is required to determine appropriateness of soldering-related designs with high precision to prevent reworking of design caused by defects that may occur during the manufacturing. In the case of manufacturing products based on a design carried out in real time, it is required, for example, to determine an inspection result of a post-reflow inspection with high precision.

### BRIEF DESCRIPTION OF THE DRAWINGS

FIG. 1 is a schematic diagram showing an example of a manufacturing system configured to manufacture products by means of soldering according to a first embodiment.

FIG. 2 is a block diagram schematically showing an example of a configuration of an information processing apparatus used at a design stage according to the first embodiment.

FIG. 3 is a schematic diagram showing an example of a machine learning model used in processing at a processing execution unit according to the first embodiment.

FIG. 4 is a flowchart schematically showing an example of a machine learning model generation process (construction process) performed by a learning model generation unit of the processing execution unit according to the first embodiment.

FIG. 5 is a block diagram schematically showing an example of processing at an image generation unit, a determination unit, and a color information setting unit in the information processing apparatus according to the first embodiment.

FIG. 6 is a schematic diagram showing an example of a process of generating input image data to be input to the machine learning model from the soldering-related design information, according to the first embodiment.

FIG. 7 is a flowchart schematically showing an example of a process of identifying a cause of defectiveness in an inspection result performed by a cause identification unit of the processing execution unit according to the first embodiment.

FIG. 8 is a schematic diagram showing a type of data input to a machine learning model and an accuracy of an output result from the machine learning model relative to an inspection result of an actually performed inspection, in regard to each of Example 1, Comparative Example 1, Comparative Example 2, and Comparative Example 3 in verification relating to the embodiment.

### DETAILED DESCRIPTION

According to an embodiment, an information processing apparatus relating to soldering of a part onto a substrate is provided. The information processing apparatus includes an image generation unit and a determination unit, and the image generation unit generates input image data showing a pre-reflow state based on soldering-related design information. The image generation unit applies a color or a pattern corresponding to color information set for each of a plurality of types of components shown in the input image data to each of the plurality of types of components based on the color information. The determination unit determines appropriateness of a design shown in the design information by inputting, to a machine learning model configured to output an inspection result of a post-reflow inspection in response to inputting of image data that is based on a pre-reflow image, the input image data in which the color or pattern corresponding to the color information is applied to each of the plurality of types of components.

Hereinafter, embodiments, etc. will be described with reference to the accompanying drawings.

### First Embodiment

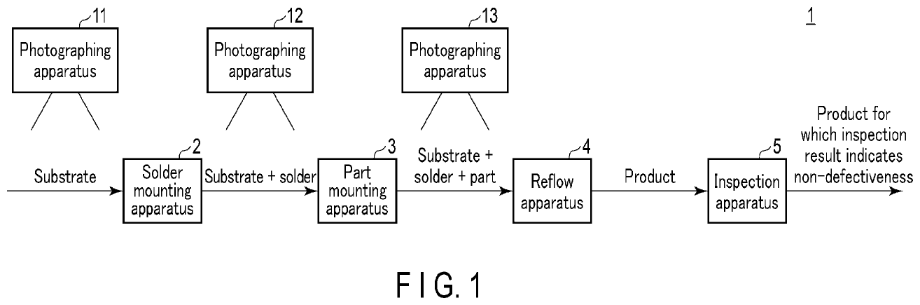

A first embodiment will be described as an example of the embodiment. FIG. 1 shows an example of a manufacturing system 1 configured to manufacture products by means of soldering according to the first embodiment. As shown in FIG. 1, etc., the manufacturing system 1 includes a solder mounting apparatus 2, a part mounting apparatus 3, a reflow apparatus 4, and an inspection apparatus 5. In the manufacturing system 1, a manufacturing line for manufacturing products is formed, and the solder mounting apparatus 2, the part mounting apparatus 3, the reflow apparatus 4, and the inspection apparatus 5 are arranged in this order from the upstream side in the manufacturing line.

In the manufacturing line, a substrate is conveyed to the solder mounting apparatus 2. Examples of the substrate that is conveyed to the solder mounting apparatus 2 include a board and a lead frame. The board conveyed to the solder mounting apparatus 2 as a substrate may be a printed wiring board, or a printed board (printed circuit board) in which a part such as a chip part is already attached to a printed wiring board. The solder mounting apparatus 2 mounts solder onto the board to be a substrate by, for example, printing solder to a pad, a land, etc. formed on a surface of the board. In one example, solder may be mounted onto a board to be the substrate by printing solder onto a surface of a part already attached to a printed board. In the solder mounting apparatus 2, room-temperature solder is mounted onto a substrate, namely, solder is mounted onto a substrate in a non-melted state.

In the solder mounting apparatus 2, in a state in which a surface of a substrate is covered with a metal mask, solder paste is filled with an opening of the metal mask, thereby transferring solder onto a pad, etc. of the substrate through the opening of the metal mask. By removing the metal mask from the substrate, only the solder transferred through the opening of the metal mask is mounted on the substrate. Thereby, the solder is printed on the substrate. A method of mounting solder onto a substrate in the solder mounting apparatus 2 is not limited to printing. In one example, solder mounting onto a substrate may be performed by either dispensing (applying) solder thereto or mounting a solder sheet thereon.

The substrate on which the solder is mounted is conveyed to the part mounting apparatus 3. The part mounting apparatus 3 mounts a part to be newly attached onto a substrate such as a board. Examples of the part to be mounted onto the substrate include, for example, chip parts, IC packages, connector parts, etc. Through the mounting of the part, the solder is interposed between the substrate and the part.

The substrate on which the solder and the part are mounted is conveyed to the reflow apparatus 4. The reflow apparatus 4 performs soldering by means of a reflow process. Through the reflow process, the solder mounted on the substrate such as the board is melted, and a newly mounted part is joined to the substrate. Thereby, a printed board, etc. is formed as a product in which the mounted part is attached to the substrate. In one example, a newly mounted part is joined to a pad, a land, etc. formed on a surface of a board, which is a substrate, by means of soldering. In another example, a newly mounted part is joined to a part already mounted on a substrate such as a board by means of soldering.

A manufactured product such as a printed board, namely, a product obtained by joining a part to a substrate by means of a reflow process in the reflow apparatus 4, is conveyed to the inspection apparatus 5. The inspection apparatus 5 inspects the product such as the manufactured printed board, and determines whether the product is defective or non-defective. Through the inspection by the inspection apparatus 5, only products determined to be non-defective are distributed to the market as distribution products.

The inspection apparatus 5 performs, for example, a visual inspection and an electricity test on the manufactured products such as printed boards. In the visual inspection, images of a product obtained by joining a part to a substrate by means of a reflow process are acquired by photography, etc., and whether the manufactured product such as the printed board is defective or non-defective is determined based on the acquired images of the product such as the printed board. In the electricity test, whether the manufactured product such as the printed board is defective or non-defective is determined by, for example, allowing electricity to flow through the product and measuring an amount of the electricity using a tester.

In the manufacturing system 1 according to the example shown in FIG. 1, photographing apparatuses 11 to 13 are provided. Each of the photographing apparatuses 11 to 13 is, for example, a camera or a video camera. The photographing apparatus 11 is arranged on an upstream side of the solder mounting apparatus 2, and photographs an image of only a substrate. The photographing apparatus 12 is arranged between the solder mounting apparatus 2 and the part mounting apparatus 3, and photographs an image of the substrate on which only solder is mounted. The photographing apparatus 13 is arranged between the part mounting apparatus 3 and the reflow apparatus 4, and photographs an image of the substrate on which the solder and a part are mounted. Thereby, in the example of FIG. 1, three types of images, namely, an image of only a substrate, an image of the substrate on which only solder is mounted, and an image of the substrate on which the solder and a part are mounted are photographed by the photographing apparatuses 11 to 13 as pre-reflow images prior to a reflow process to be performed by the reflow apparatus 4.

In the case of manufacturing a product such as a printed board by means of soldering, as described above, soldering-related designs are carried out before mounting of solder and a part onto a substrate. In the soldering-related designs, a design regarding a substrate such as a board, a design for a metal mask used in mounting of solder onto the substrate, and a design regarding a part, for example, are carried out. In the present embodiment, at a design stage prior to mounting of solder, etc. onto the substrate, namely, prior to start of manufacturing, processing using an information processing apparatus 6, to be described below, is carried out.

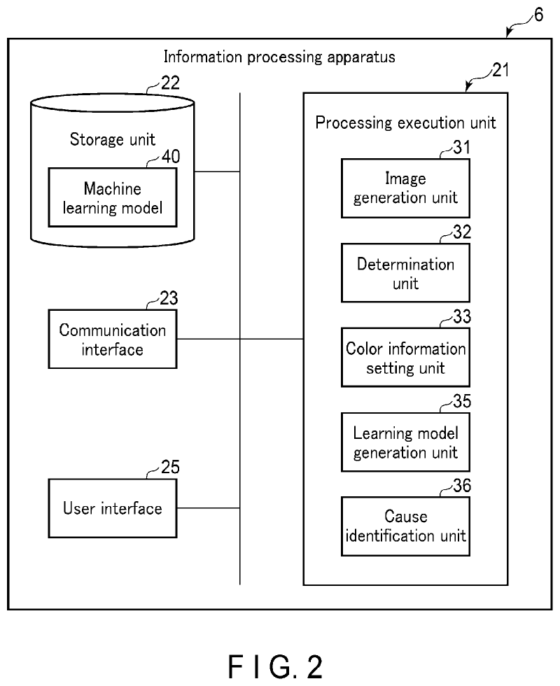

FIG. 2 shows an example of a configuration of the information processing apparatus 6 used at the design stage according to the present embodiment. As shown in FIG. 2, the information processing apparatus 6 includes a processing execution unit 21, a storage unit 22, a communication interface 23, and a user interface 25. In the example of FIG. 2, the processing execution unit 21 includes an image generation unit 31, a determination unit 32, a color information setting unit 33, a learning model generation unit 35, and a cause identification unit 36. Each of the image generation unit 31, the determination unit 32, the color information setting unit 33, the learning model generation unit 35, and the cause identification unit 36 performs part of the processing performed by the processing execution unit 21.

In one example, the information processing apparatus 6 is configured of a computer, etc., and a processor or an integrated circuit of the computer functions as the processing execution unit 21. A processor or an integrated circuit of a computer includes one of a central processing unit (CPU), an application-specific integrated circuit (ASIC), a graphics processing unit (GPU), a microcomputer, a field-programmable gate array (FPGA), a digital signal processor (DSP), etc. The number of integrated circuits, etc. included in a computer that functions as the information processing apparatus 6 may be either one or more than one.

In a computer that functions as the information processing apparatus 6, a storage medium (non-transitory storage medium) of the computer functions as the storage unit 22. The storage medium may include an auxiliary storage in addition to a primary storage such as a memory. Examples of the storage medium include magnetic disks, optical disks (CD-ROMs, CD-Rs, DVDs, etc.), magneto-optical disks (MOS, etc.), semiconductor memories, etc. The computer that functions as the information processing apparatus 6 may include only one storage medium, etc., or a plurality of storage media.

In a computer that functions as the information processing apparatus 6, a processor or an integrated circuit executes programs, etc. stored in the storage medium, etc., and thereby processing by the processing execution unit 21, to be described below, is performed. The processing to be described below is executed by a processor, etc. performing an information processing program stored in a storage medium, etc. In one example, in a computer that functions as the information processing apparatus 6, programs to be executed by a processor, etc. may be stored in, for example, a computer (server) connected via a network such as the Internet or a server such as a cloud environment. In this case, the processor downloads the programs via the network.

In one example, the information processing apparatus 6 is configured of a plurality of computers that are separate from one another. In this case, processing by the processing execution unit 21, to be described below, is performed by processors, integrated circuits, etc. of the computers.

In one example, the information processing apparatus 6 is configured of a server of a cloud environment. The infrastructure of the cloud environment is configured of a virtual processor such as a virtual CPU and a cloud memory. In the server of the cloud environment of which the information processing apparatus 6 is configured, a virtual processor, etc. functions as the processing execution unit 21, and processing by the processing execution unit 21, to be described below, is performed by the virtual processor, etc. The cloud memory functions as the storage unit 22.

In the information processing apparatus 6, the communication interface 23 is configured of an interface that accesses external devices. The information processing apparatus 6 is capable of communicating, either in a wired or wireless manner, with an external device via the communication interface 23.

In the information processing apparatus 6, various types of operations, etc. are input by users, etc. of the information processing apparatus 6, including a designer who carries out soldering-related designs, via the user interface 25. At the user interface 25, one of a button, a switch, a touch panel, etc. is provided as an operation member to which an operation is input by a user, etc. of the information processing apparatus 6. In the user interface 25, various types of information are reported to a user, etc. of the information processing apparatus 6. The reporting of the information is performed by, for example, screen display, audio broadcasting, or the like. In one example, the user interface 25 is provided as an external device of the information processing apparatus 6, and is provided separately from the computer, etc. that configures the information processing apparatus 6.

Hereinafter, processing performed by the processing execution unit 21 will be described. As shown in FIG. 2, etc., the storage unit 22 stores a machine learning model 40 generated (constructed) as will be described below. The processing execution unit 21 performs processing using the machine learning model 40.

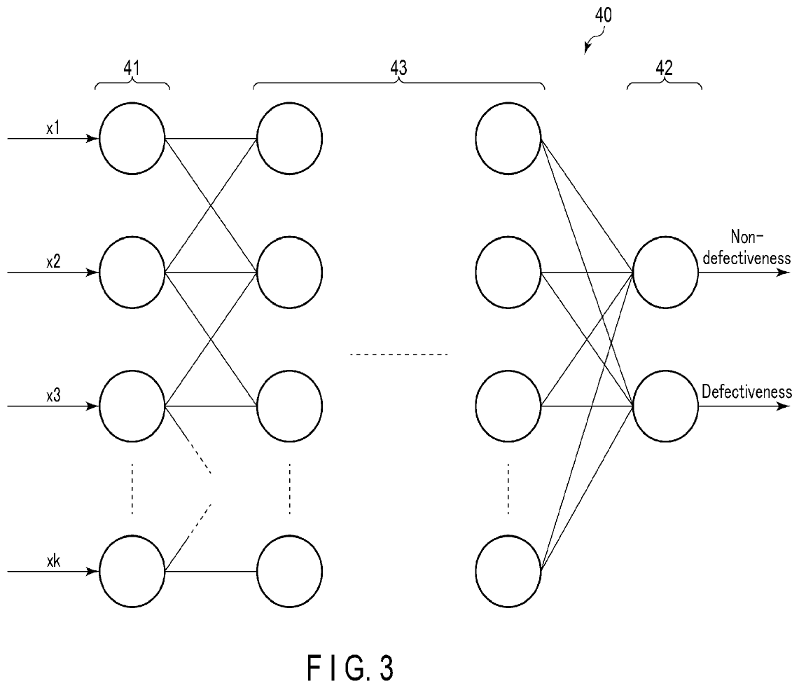

FIG. 3 shows an example of the machine learning model 40 used in processing at the processing execution unit 21. As shown in FIG. 3, etc., the machine learning model 40 is configured of an input layer 41, an output layer 42, and an intermediate layer (hidden layer) 43 between the input layer 41 and the output layer 42. In the machine learning model 40, in response to image data based on pre-reflow images prior to a reflow process to be performed by the reflow apparatus 4 being input to the input layer 41, an inspection result of a post-reflow inspection by the inspection apparatus 5 is output from the output layer 42.

The image data to be input to the input layer 41 of the machine learning model 40 is generated based on a plurality of types of images showing pre-reflow states by, for example, lining up a plurality of types of images showing pre-reflow states. In one example, image data to be input to the machine learning model 40 is generated by lining up three types of images, namely, an image of only the substrate such as a board, an image of the substrate on which only solder is mounted, and an image of the substrate on which the solder and a part are mounted.

If the above-described image data based on the pre-reflow images is input to the machine learning model 40, pixel-by-pixel pixel information, such as RGB values, is input to the input layer 41 in regard to all the images configuring the image data. If, for example, image data in which a plurality of types of images showing pre-reflow states are lined up as described above is input to the machine learning model 40, pixel-by-pixel pixel information of all of the plurality of types of images that are lined up is input to the input layer 41.

In the machine learning model 40 according to the example of FIG. 3, the input layer 41 is configured of the same number of nodes as the total number of the pixels in all the images configuring the input image data. In the example of FIG. 3, upon inputting of image data to the machine learning model 40, pixel information items x1 to xk are input to the input layer 41, where k is the total number of pixels in all the images configuring the input image data.

In the machine learning model 40 in the example of FIG. 3, whether or not defectiveness will occur in a post-reflow inspection is output from the output layer 42. Thus, in the machine learning model 40, the output layer 42 is configured of a node configured to output information indicating that defectiveness will not occur in the inspection, and a node configured to output information indicating that defectiveness will occur in the inspection.

Also, the intermediate layer 43 is configured of a plurality of convolutional layers, a plurality of pooling layers, a fully connected layer, etc. In each of the convolutional layers, one or more feature parts in the image are extracted by performing a filtering process on each pixel. In each of the pooling layers, the image is reduced in size, while maintaining the feature parts of the image. Through the processing at the pooling layers, position gaps of the feature parts in the image configuring the image data input to the machine learning model 40 are absorbed. In the intermediate layer 43, features of the image are recognized through the processing at the convolutional layers and the pooling layers.

In the fully connected layer, the image data of which the feature parts have been recognized at the convolutional layers and the pooling layers is converted into one-dimensional data. Through the above-described processing, the feature parts in the image are recognized in the intermediate layer 43 of the machine learning model 40. The recognized feature parts are converted into information used for determining whether or not defectiveness will occur in the inspection.

In the present embodiment, the machine learning model 40 is generated (constructed) by a learning model generation unit 35. In the generation of the machine learning model 40, learning data configured of a large number of data sets is used. In each of the data sets of the learning data, image data based on the plurality of types of pre-reflow images is shown for a product such as a printed board on which an inspection has been previously performed. The image data shown in each of the data sets is generated by, for example, lining up a plurality of types of images showing pre-reflow states. In one example, the image data in each of the data sets of the learning data is generated by photography in which pre-reflow states are photographed. In this case, the image data in each of the data sets is generated by, for example, lining up three types of photography images photographed by the photographing apparatus 11 to 13.

In each of the data sets of the learning data, an inspection result of a post-reflow inspection that has been actually performed is shown for a product such as a printed board on which an inspection has been previously performed. In each data set, the image data and the inspection result described above may be shown in regard to a product that has been previously inspected in the manufacturing system 1, or the image data and the inspection result described above may be shown in regard to a product that has been previously inspected in another manufacturing system with a configuration similar to the manufacturing system 1.

Since the learning data is configured as described above, in each of the large number of data sets of the learning data, image data based on pre-reflow images and an inspection result of a post-reflow inspection that has been actually performed are associated with each other in regard to a product such as a printed board that has been previously inspected. It is to be noted that the inspected products differ among the large number of data sets.

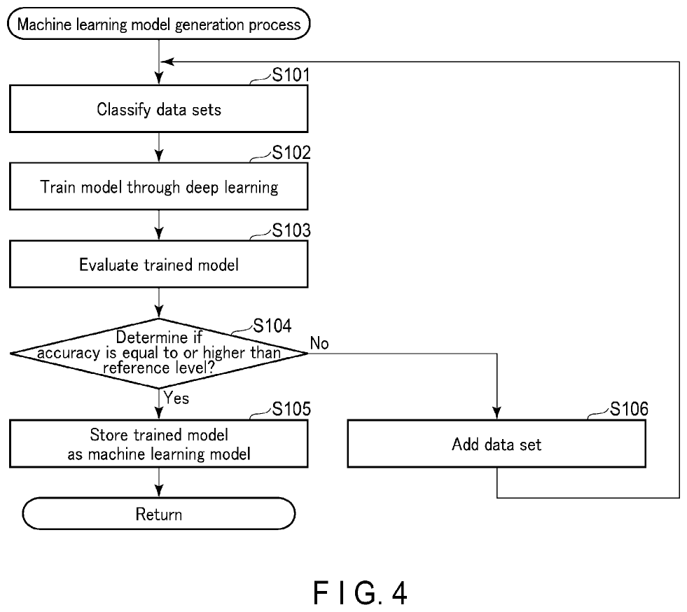

FIG. 4 shows an example of a generation process (construction process) of the machine learning model 40 by the learning model generation unit 35. If processing of FIG. 4 is started, the learning model generation unit 35 classifies the large number of data sets of the learning data into a training data set and an evaluation data set (S101). In one example, a large number of data sets are classified in such a manner that the ratio of the number of the training data sets to the number of the evaluation data sets becomes 9.

The learning model generation unit 35 trains a model through deep learning using the training data sets of the learning data (S102). At this time, a neural network, for example, is trained as the model. The model is trained through supervised learning in which an inspection result shown in each of the training data sets is given as a correct answer. Through deep learning, the model learns features contained in the image data of the training data sets, and learns, for example, features in the image data in the case where the inspection result indicates defectiveness.

Upon completing the training using the training data sets, the learning model generation unit 35 evaluates the trained model using the evaluation data sets (S103). In the evaluation of the model, image data based on pre-reflow images is input to the trained model, in regard to each of the evaluation data sets. A comparison is made between an output result from the trained model and an inspection result of an inspection that has been actually performed, in regard to each of the evaluation data sets. As an index for evaluating the trained model, an accuracy of an output result from the model relative to the inspection result of the actually performed inspection is calculated.

After completing the evaluation using the evaluation data sets, the learning model generation unit 35 determines whether or not the accuracy calculated as the index for evaluating the trained model is equal to or higher than a reference level (S104). In one example, the accuracy is determined to be equal to or higher than a reference level based on the accuracy being equal to or higher than 90%. If the accuracy is equal to or higher than the reference level (S104—Yes), the learning model generation unit 35 stores, in the storage unit 22, the trained model as the above-described machine learning model 40 to be used in processing (S105).

If the accuracy is lower than the reference level (S104—No), the learning model generation unit 35 adds a data set to the learning data (S106). The processing returns to S121, and the learning model generation unit 35 sequentially performs the processing at S101 and thereafter. Thereby, training of the model using the added data set and the evaluation of the model using the added data set are performed. It is to be noted that the learning model generation unit 35 need not be necessarily provided in the information processing apparatus 6. In one example, a generation process (construction process) of the above-described machine learning model 40 is performed by a computer, etc. different from the information processing apparatus 6.

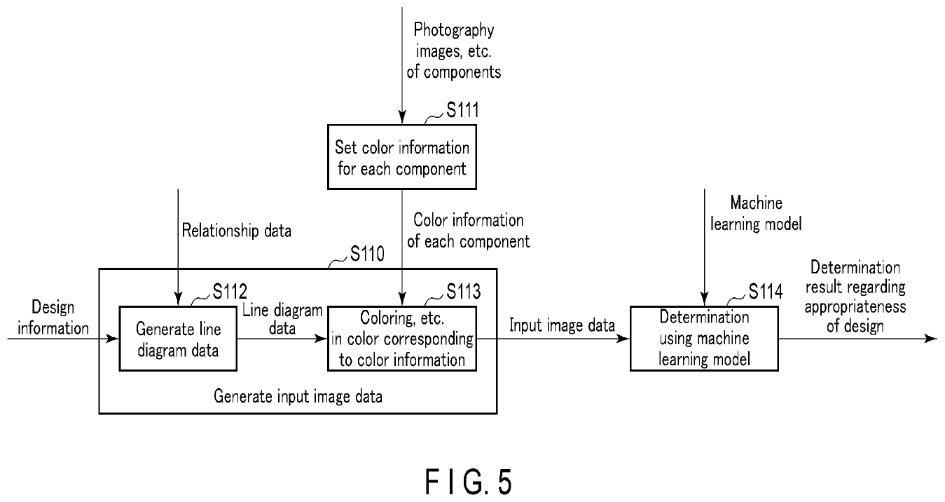

FIG. 5 shows an example of processing at the image generation unit 31, the determination unit 32, and the color information setting unit 33 in the information processing apparatus 6 according to the present embodiment. The processing shown in FIG. 5 is, for example, carried out every time soldering-related design information is generated at a design stage prior to start of manufacturing. As shown in FIG. 5, the image generation unit 31 generates input image data showing pre-reflow states as data to be input to the machine learning model 40 (S110). Soldering-related design information is input to the image generation unit 31, and the image generation unit 31 generates input image data based on the input design information.

Computer-aided design (CAD) data, for example, is input to the image generation unit 31 as soldering-related design information. As the soldering-related design information, design information of a substrate such as a board, design information of a metal mask used in mounting of solder onto the substrate, and design information of a part to be mounted are shown. In the input image data, a plurality of types of pre-reflow images are shown, for example, a plurality of types of images showing pre-reflow states are lined up. In one example, three types of images, namely, an image of only a substrate such as a board, an image of the substrate on which only solder is mounted, and an image of the substrate on which the solder and a part are mounted are lined up as images showing pre-reflow states in the input image data.

In the input image data, a plurality of types of components are shown in a plurality of types of images showing pre-reflow states. The plurality of types of components shown in the input image data contain solder and a part, and include one or more of the components configuring the substrate. Examples of the components configuring the substrate such as the board include a resist, a pad, a land, and an isolation portion.

The color information setting unit 33 sets color information for each of the plurality of types of components shown in the input image data (S111). The color information is set for each of the plurality of types of components. Different color information is set for the plurality of types of components shown in the input image data. The plurality of types of components are distinguished from one another by the color information, and each of the plurality of types of components is identified by the color information. Thus, corresponding color information is associated with each of the plurality of types of components.

Photography images of the plurality of types of components shown in the input image data, for example, is input to the color information setting unit 33. In one example, photography images, etc. obtained by photographing pre-reflow states of a product that has been previously inspected are input to the color information setting unit 33, and photography images previously obtained by the photographing apparatuses 11 to 13, for example, are input to the color information setting unit 33. The color information setting unit 33 identifies a color or a pattern of each of the plurality of types of components based on the input photography images. The color information setting unit 33 sets color information showing the identified color or pattern for each of a plurality of types of components. The color information regarding each of the plurality of types of components is input to the image generation unit 31.

In generating the input image data (S110), the image generation unit 31 generates line diagram data based on soldering-related design information (S112). In the line diagram data, a plurality of types of line diagrams (line drawing images) showing pre-reflow states are lined up. In one example, three types of line diagrams, namely, a line diagram of only a substrate such as a board, a line diagram of the substrate on which only solder is mounted, and a line diagram of the substrate on which the solder and a part are mounted are lined up as line diagrams (line drawing images) showing pre-reflow states in the line diagram data. In the line diagram data, a plurality of types of components are shown, and components identical to the components shown in the input image data are shown. In the line diagram data, however, a color or a pattern is not applied to each of the plurality of types of components.

In generating the line diagram data (S112), the image generation unit 31 generates an outline element of each of the plurality of types of components in the line diagram data based on at least the soldering-related design information. The outline element of each of the plurality of types of components is shown by a line, and a color or a pattern is not applied thereto. In each of the plurality of types of line diagrams shown in the line diagram data, an outline element of each of the components is shown at a position corresponding to the soldering-related design information, and the outline element of each component is shown in a shape corresponding to at least the soldering-related design information. As the outline elements of the plurality of types of components, outline elements of one or more types of components configuring the substrate, an outline element of the solder, and an outline element of the part to be mounted are generated.

The image generation unit 31 forms the outline elements of the one or more types of components configuring the substrate based on at least the design information of the substrate. In the design information of the substrate, design shapes of the respective components configuring the substrate are shown. The outline element of each of the components configuring the substrate is formed in a shape corresponding to the design shape of the component shown in the design information of the substrate. An outline element of a pad is formed in, for example, a shape corresponding to a design shape of the pad shown in the design information of the substrate. In each of the plurality of types of line diagrams shown in the line diagram data, the outline elements of one or more types of components configuring the substrate are respectively shown at positions corresponding to the design information of the substrate.

Also, the image generation unit 31 forms an outline element of a part to be mounted on the substrate based on the design information of the part. In the design information of the part, a design shape of the part is shown. An outline element of the part, which is one of the plurality of types of components, is formed in a shape corresponding to the design shape of the part shown in the design information of the part. In the line diagram data, the outline element of the part is shown at a position corresponding to the design information of the part in the line diagram of the substrate on which the solder and the part are mounted.

Also, the image generation unit 31 forms an outline element of the solder based on the design information of the metal mask used in mounting of solder onto the substrate. In the design information of the metal mask, a design shape of an opening of the metal mask is shown. The outline element of the solder, which is one of the plurality of types of components, is formed in a shape corresponding to at least the design shape of the opening shown in the design information of the metal mask. In the line diagram data, the outline element of the solder is shown at a position corresponding to the design information of the metal mask in each of the line diagram of the substrate on which only the solder is mounted and the line diagram of the substrate on which the solder and the part are mounted.

If the solder is mounted onto the substrate by transferring the solder through the opening of the metal mask, part of the solder filled with the opening may be adhered to the metal mask removed from the substrate, or part of the solder filled with the opening may drip onto a side on which the substrate is located. Thus, the shape of the solder mounted on the substrate is not necessarily identical to the shape of the opening of the metal mask. In the example of FIG. 5, the image generation unit 31 generates the outline element of the solder based on relationship data indicating a relationship between the opening of the metal mask and the shape of the solder mounted on the substrate, in addition to the design information of the metal mask. The relationship data is stored in, for example, a storage unit 22.

In the example of FIG. 5, the image generation unit 31 corrects the design shape of the opening shown in the design information of the metal mask based on the relationship data indicating the relationship between the opening of the metal mask and the shape of the solder mounted on the substrate. The image generation unit 31 generates the outline element of the solder by correcting the design shape of the opening in accordance with the relationship data. Thus, in the example of FIG. 5, the outline element of the solder, which is one of the plurality of types of components, is formed in a shape corresponding to the design shape of the opening shown in the design information of the metal mask and to the relationship data indicating the relationship between the opening of the metal mask and the solder mounted on the substrate. Also, in the example of FIG. 5, line diagram data is generated using the outline element of the solder generated based on the design information of the metal mask and the relationship data.

In one example, the outline element of the solder is formed without using the relationship data. In this case, the outline element of the solder, which is one of the plurality of types of components, is formed, for example, without correcting the design shape of the opening shown in the design information of the metal mask.

In generating the input image data (S110), upon generating line diagram data, the image generation unit 31 performs, for example, coloring of each of the plurality of types of components shown in the line diagram data in a color corresponding to the color information set by the color information setting unit 33 (S113). That is, the image generation unit 31 applies colors or patterns corresponding to the set color information to the outline elements of the respective types of components shown in the line diagram data. Thereby, input image data in which colors or patterns corresponding to the color information are applied to the respective types of components is generated based on the line diagram data in which the plurality of types of components are shown using only lines.

In one example, regarding the colors or patterns applied to the respective types of components, only one color or pattern corresponding to the color information is set. In this case, the set color or pattern is applied to each of the plurality of types of components in the input image data. In another example, regarding the colors or patterns applied to the respective types of components, a color range or a pattern range corresponding to the color information is set. In this case, a color included in the set color range or a pattern included in the set pattern range is applied to each of the plurality of types of components in the input image data. In either case, a color or a pattern is applied to each of the plurality of types of components in the input image data in such a manner that the plurality of types of components are distinguished from one another based on the color or pattern, and that each of the plurality of types of components is identified based on the color or pattern.

Moreover, in the input image data, a color or a pattern corresponding to the color information of the solder is applied to a portion at which the solder overlaps the substrate. Furthermore, in the input image data, a color or a pattern corresponding to the color information of the part is applied to a portion at which the part overlaps at least one of the solder and the substrate.

The determination unit 32 determines appropriateness of the design shown in the soldering-related design information using the machine learning model 40 (S114). In determining the appropriateness of the design, the determination unit 32 inputs, to the input layer 41 of the machine learning model 40, the input image data generated by the image generation unit 31. Based on an output result output from the output layer 42 of the machine learning model 40 in response to the inputting of the input image data, the determination unit 32 determines appropriateness of the design. That is, the determination unit 32 causes the machine learning model 40 to output an inspection result of a post-reflow inspection in response to the inputting of the input image data, and determines appropriateness of the design based on the inspection result output from the machine learning model 40.

If the inspection result output from the machine learning model 40 indicates non-defectiveness, the determination unit 32 determines that the design shown in the design information is appropriate. On the other hand, if the inspection result output from the machine learning model 40 indicates defectiveness, the determination unit 32 determines that the design shown in the design information is inappropriate. The determination unit 32 outputs a result of the determination regarding the appropriateness of the design shown in the soldering-related design information. In one example, the processing execution unit 21 causes a user interface 25 to report the result of the determination at the determination unit 32.

In the input image data to be input to the machine learning model 40, the color or pattern corresponding to the color information is applied to each of the plurality of types of components. The plurality of types of components are distinguished from one another by the color information, and each of the plurality of types of components is identified by the color information. Thus, the machine learning model 40 identifies each of the plurality of types of components based on the color or pattern in each of the plurality of types of images shown in the input image data.

It is assumed, for example, that components C1 and C2 are included in the plurality of types of components shown in the input image data, and color information items α1 and α2 are respectively set for the components C1 and C2. In this case, the machine learning model 40 identifies a portion to which a color or a pattern corresponding to the color information α1 is applied in the input image data as the component C1, and a portion to which a color or a pattern corresponding to the color information α2 is applied as the component C2.

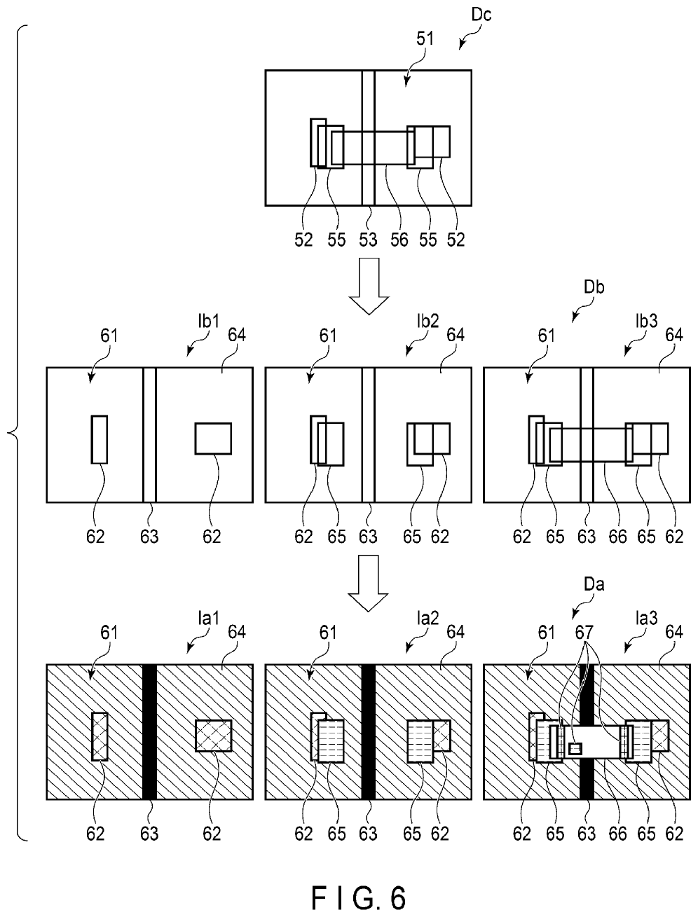

FIG. 6 shows an example of a process of generating input image data to be input to the machine learning model from the soldering-related design information, according to the present embodiment. In the example of FIG. 6, CAD data Dc is used as the soldering-related design information. In the CAD data Dc, a board shape 51 is shown as a portion corresponding to the entirety of a board, which is a substrate. In the CAD data Dc, a design shape 52 of a pad and a design shape 53 of an isolation portion are shown on the board shape 51 as the design information of the board. In the CAD data Dc, a portion other than the design shape 52 of the pad and the design shape 53 of the isolation portion on the board shape 51 is designed as a resist.

In the CAD data Dc, a design shape 55 of an opening of a metal mask is shown as the design information of the metal mask. In the CAD data Dc, a design shape 56 of a part is shown as the design information of the part. In the CAD data Dc, design shapes 52 to 56 are shown only by lines, and a color or a pattern is not applied to the design shapes 52 to 56.

In the example of FIG. 6, line diagram data Db is generated based on at least the CAD data Dc. In the line diagram data Db, a line diagram Ib1 of only a board, which is a substrate, a line diagram Ib2 of the board on which only solder is mounted, and a line diagram Ib3 of the board on which the solder and a part are mounted are lined up.

In each of the line diagrams (line drawing images) Ib1 to Ib3, a board shape 61 is shown as a portion corresponding to the entirety of the board, which is the substrate. In each of the line diagrams Ib1 to Ib3, an outline element 62 of the pad, an outline element 63 of the isolation portion, and an outline element 64 of the resist are shown as outline elements of the components configuring the board. In each of the line diagrams Ib1 to Ib3, a portion other than the outline element 62 of the pad and the outline element 63 of the isolation portion on the board shape 61 is the outline element 64 of the resist. Each of the outline elements 62 to 64 is generated based on at least the design information of the board, and is formed in a shape corresponding to at least the design shape 52 of the pad, the design shape 53 of the isolation portion, etc.

In the line diagram data Db, an outline element 65 of the solder is shown in each of the line diagrams Ib2 and Ib3. The outline element 65 of the solder is generated based on at least the design information of the metal mask, and is formed in a shape corresponding to at least the design shape 55 of the opening of the metal mask. The outline element 65 of the solder may be generated based on relationship data indicating a relationship between the opening of the metal mask and the shape of the solder mounted on the board, in addition to the design information of the metal mask. In the line diagram data Db, an outline element 66 of the part is shown in the line diagram Ib3. The outline element 66 of the part is generated based on at least the design information of the part, and is formed in a shape corresponding to at least the design shape 56 of the part.

In the example of FIG. 6, input image data Da is generated by applying a color or a pattern corresponding to color information to each of the plurality of types of components in the line diagram data Db. In the input image data Da, an image Ia1 of only a board, which is a substrate, an image Ia2 of the board on which only solder is mounted, and an image Ia3 of the board on which the solder and a part are mounted are lined up. The images Ia1, Ia2, and Ia3 are generated by applying a color or a pattern corresponding to the color information to each of the components in the line diagrams Ib1, Ib2, and Ib3.

In the example of FIG. 6, the outline element 62 of the pad is colored in orange in accordance with the color information set for the pad, and the outline element 63 of the isolation portion is colored in black in accordance with the color information set for the isolation portion. The outline element 64 of the resist is colored in green in accordance with the color information set for the resist, and the outline element 65 of the solder is colored in gray in accordance with the color information set for the solder. As for the outline element 66 of the part, a portion 67 is colored in yellow, and a portion other than the portion 67 is colored in white, in accordance with the color information set for the part. In the portion at which the solder overlaps the board, a color corresponding to the color information of the solder is applied, and a color corresponding to the color information of the part is applied to a portion at which the part overlaps at least one of the solder and the board.

In the present embodiment, if an inspection result of a post-reflow inspection output from the machine learning model 40 in response to inputting of input image data to the machine learning model 40 indicates defectiveness, the cause identification unit 36 identifies a cause of the defectiveness indicated by the inspection result. At this time, the cause identification unit 36 identifies, using Explainable Artificial Intelligence (XAI) technology, the cause of the defectiveness. The cause of the defectiveness indicated by the inspection result is identified by at least one of the input image data input to the machine learning model 40, the design information such as CAD data used in generating the input image data, and data generated in the process of generating the input image data from the design information. Examples of the data generated in the process of generating the input image data from the design information include the above-described line diagram data, etc.

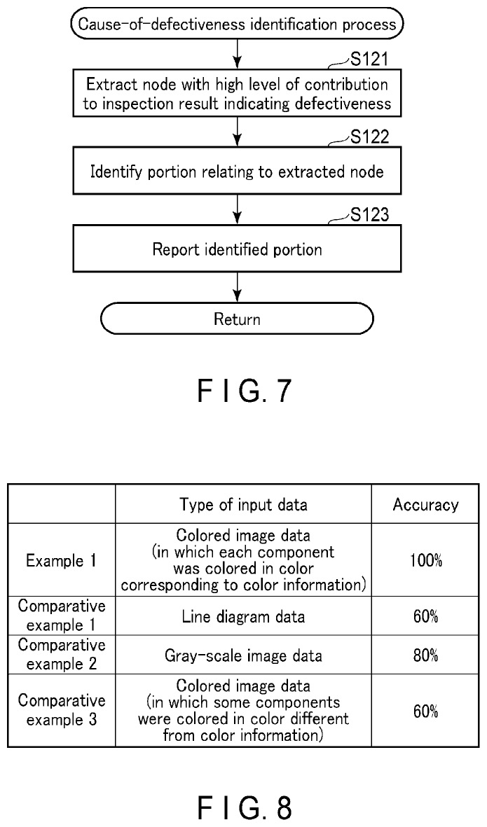

FIG. 7 shows an example of an identification process of the cause of the defectiveness indicated by the inspection result performed by the cause identification unit 36. The processing in the example of FIG. 7 is carried out if the post-reflow inspection result output from the machine learning model 40 indicates defectiveness, namely, if the determination unit 32 determines that the design shown in the soldering-related design information is inappropriate. Upon starting of the processing in the example of FIG. 7, the cause identification unit 36 extracts a node with a high level of contribution to the inspection result indicating defectiveness from the intermediate layer 43 and the input layer 41 of the machine learning model (S121). That is, a node with a high level of contribution to an output result from a node that outputs information indicating that defectiveness will occur in the output layer 42 is extracted from the intermediate layer 43 and the input layer 41.

The cause identification unit 36 identifies a portion relating to a node extracted as a node with a high level of contribution to the defectiveness determination from one or more of the input image data having been input to the machine learning model 40, the design information used for generating the input image data, and the data generated in the process of generating the input image data from the design information (S122). Thereby, a portion relating to the extracted node in one or more of the input image data, the design data, and the data generated in the process of generating the input image data is identified as the cause of the defectiveness.

The cause identification unit 36 causes the user interface 25, etc. to report the portion identified as the cause of the defectiveness (S123). At this time, in one example, in the input image data or the CAD data to be the design information, the portion identified as the cause of the defectiveness is reported by, for example, enclosing the portion identified as the cause of the defectiveness with a frame. If, for example, an outline element of a single pad is enclosed by a frame in the input image data, or if a design shape of a single pad is enclosed by a frame in the design information, the design for the pad enclosed by the frame can be recognized as the cause of the defectiveness indicated by the inspection result. In one example, the processing by the cause identification unit 36 need not be performed.

As described above, in the present embodiment, input image data showing pre-reflow states is generated based on soldering-related design information, and a color or a pattern corresponding to color information set for each of a plurality of types of components shown in the input image data is applied to each of the plurality of types of components based on the color information. By inputting, to a machine learning model 40 configured to output an inspection result of a post-reflow inspection in response to inputting of image data that is based on pre-reflow images, input image data in which a color or a pattern corresponding to the color information is applied to each of the plurality of types of components, appropriateness of the design shown in the design information is determined. At a design stage prior to start of manufacturing, appropriateness of soldering-related designs can be determined with high precision. It is possible, for example, to determine, with high precision, an inspection result of a post-reflow inspection in the case of manufacturing products based on a design carried out in real time.

In the present embodiment, the color information is set in such a manner that the plurality of types of components are distinguished from one another by the color information, and that each of the plurality of types of components is identified by the color information. Thus, by applying a color or a pattern corresponding to the color information to each of the plurality of types of components shown in the input image data, the machine learning model 40 can appropriately identify each of the plurality of types of components in the input image data based on the color or pattern. Thereby, precision in determining appropriateness of soldering-related designs using the machine learning model 40 is further improved.

In the present embodiment, in generating the input image data, an outline element of each of the plurality of types of components is generated based on at least the soldering-related design information. In the generating of the input image data, a color or a pattern corresponding to color information set for each of the plurality of types of components is applied to the generated outline element. Thereby, input image data to which a color or a pattern corresponding to the color information of each of the plurality of types of components is applied is appropriately generated using the design information.

In one example of the present embodiment, in generating input image data, an outline element of solder is formed based on relationship data indicating a relationship between an opening of a metal mask and a shape of the solder mounted on a substrate in addition to design information of the metal mask. Thereby, an outline element of the solder, which is one of the plurality of types of components, is formed in a further appropriate manner.

In the present embodiment, in generating of the machine learning model 40, a model is trained through deep learning using learning data in which image data based on images showing pre-reflow states is associated with an inspection result of a post-reflow inspection that has been actually performed. Thus, a machine learning model 40 configured to appropriately output, in response to inputting of image data that is based on pre-reflow images, an inspection result at a post-reflow inspection is generated.

In one example of the present embodiment, if an inspection result of a post-reflow inspection output from the machine learning model 40 in response to inputting of input image data to the machine learning model 40 indicates defectiveness, the cause of the defectiveness indicated by the inspection result is identified in at least one of: the input image data; design information used for generating the input image data; and data generated in a process of generating the input image data from the design information. Thereby, a designer, etc. can quickly and appropriately find which of the soldering-related designs is the cause of the defectiveness indicated by the inspection result.

### Modifications

In the above-described embodiment, etc., color information is set for each of the plurality of types of components based on photography images of the plurality of types of components. In a modification, the color information setting unit 33 sets color information for each of the plurality of types of components based on an operation input by a designer, etc. at the user interface 25. In this case, for example, a designer, etc. recognizes a color or a pattern of each of the plurality of types of components based on the substrate, the solder, the part, etc. that are actually used. The designer, etc. inputs the recognized color or pattern for each of the plurality of types of components based on an operation input at the user interface 25. The color information setting unit 33 sets color information showing the color or pattern input by the designer, etc. for each of a plurality of types of components.

However, in the present modification, the plurality of types of components are distinguished from one another by the color information, and each of the plurality of types of components is identified by the color information. Thus, in the present modification, too, the machine learning model 40 identifies each of the plurality of types of components based on the color or pattern in each of the plurality of types of images shown in the input image data.

In the above-described embodiment, three types of images, namely, an image of only a substrate, an image of the substrate on which only solder is mounted, and an image of the substrate on which the solder and a part are mounted are generated as pre-reflow images shown in the input image data; however, the configuration is not limited thereto. In a modification, only two of the above-described three types of pre-reflow images are used to generate input image data to be input to the machine learning model 40. Accordingly, it suffices that, in the input image data to be input to the machine learning model 40, a plurality of types of images showing pre-reflow states are shown.

In a modification, information indicating reflow conditions is input to the machine learning model 40, in addition to the input image data showing pre-reflow states. In this case, too, in response to inputting of input image data, etc., to the machine learning model 40, an inspection result of a post-reflow inspection is output from the machine learning model 40. Similarly to the above-described embodiment, etc., appropriateness of design shown in soldering-related design information is determined based on the result output from the machine learning model 40. The information indicating the reflow conditions includes specification information of the reflow apparatus 4 and an environmental temperature, etc. of an environment under which the reflow process is performed.

In a modification, in addition to the above-described input image data showing pre-reflow states, at least one of solder thickness information and position information regarding a height direction (a thickness direction of the substrate, the solder, and the part) in each of the images shown in the input image data may be input to the machine learning model. As the position information regarding the height direction in each of the images shown in the input image data, a height distribution, etc. in each of the images is shown. In the present modification, too, in response to inputting of input image data, etc., to the machine learning model 40, an inspection result of a post-reflow inspection is output from the machine learning model 40. Similarly to the above-described embodiment, etc., appropriateness of design shown in soldering-related design information is determined based on the result output from the machine learning model 40.

### Verification Relating to Embodiment

As a verification relating to the embodiment, the following verification was performed. In the verification, a machine learning model similar to the above-described machine learning model 40 was used. That is, verification was performed using a machine learning model configured to output, in response to inputting of image data that is based on pre-reflow images, an inspection result at a post-reflow inspection.

In the verification, a plurality of printed boards manufactured as products by means of soldering were used, and in actuality, five printed boards manufactured as products were used. An inspection was performed on each of the printed boards using an inspection apparatus similar to the inspection apparatus 5. A plurality of types of photography images showing pre-reflow states were photographed for each of the printed boards. Three types of photography images, namely, a photography image of only a board, which is a substrate, a photography image of the board on which only solder is mounted, and a photography image of the board on which the solder and a part are mounted were photographed, in regard to each of the printed boards. In each of the printed boards, a board configured of a resist, a pad, and an isolation portion was used as the board to be the substrate.

In the verification, data to be input to the machine learning model was generated using the three types of photography images showing pre-reflow states for each of the printed boards. In regard to each of the printed boards, the generated data was input to the machine learning model, and an inspection result of a post-reflow inspection was output from the machine learning model. The output result from the machine learning model and an inspection result of an actually performed inspection were compared for each of the printed boards. An accuracy of the output result from the machine learning model relative to the inspection result of the actually performed inspection was calculated.

In the verification, data to be input to the machine learning model was generated in each of four patterns, namely, Example 1, Comparative Example 1, Comparative Example 2, and Comparative Example 3, to be described below, and the accuracy was calculated for each of Example 1 and Comparative Examples 1-3. The type of data (image data) input to the machine learning model varied among Example 1, Comparative Example 1, Comparative Example 2, and Comparative Example 3. FIG. 8 shows the type of data input to the machine learning model and the accuracy of the output result from the machine learning model relative to the inspection result of the actually performed inspection in the verification, in regard to each of Example 1, Comparative Example 1, Comparative Example 2, and Comparative Example 3.

As shown in FIG. 8, in Example 1, colored image data similar to the input image data of the above-described embodiment, etc. was input to the machine learning model. In generating of the colored image data, three types of colored images, namely, a colored image of only a board, a colored image of the board on which only solder is mounted, and a colored image of the board on which the solder and a part are mounted were generated from three types of photography images showing pre-reflow states. By lining up the three types of colored images, colored image data was generated.

In the colored image data, each of the components shown in the colored images was colored in a color corresponding to the color information, similarly to the above-described embodiment, etc. In actuality, in the colored image data of Example 1, colors similar to those in the input image data Da in the example of FIG. 6 were applied to the respective components. Accordingly, in the colored image data, the pad was colored in orange, the isolation portion was colored in black, the resist was colored in green, and the solder was colored in gray. In the colored image data, a predetermined portion of the part was colored in yellow, and a portion other than the predetermined portion was colored in white.

In Comparative Example 1, line diagram data (line drawing image data) was input to the machine learning model. In generating of the line diagram data, three types of line diagrams (line drawing images), namely, a line diagram of only a board, a line diagram of the board on which only the solder is mounted, and a line diagram of the board on which the solder and a part are mounted were generated from the three types of photography images showing pre-reflow states. By lining up the three types of line diagrams, the line diagram data was generated. In the line diagram data, a color or a pattern was not applied to the components shown in each of the line diagrams.

In Comparative Example 2, gray-scale image data was input to the machine learning model. In generating of the gray-scale image data, three types of gray-scale images, namely, a gray-scale image of only a board, a gray-scale image of the board on which only solder is mounted, and a gray-scale image of the board on which the solder and a part are mounted were generated from the three types of photography images showing pre-reflow states. By lining up the three types of gray-scale images, gray-scale image data was generated. Since the gray-scale image data was generated as described above, at least some of the components were colored in a color different from the color information.

In Comparative Example 3, colored image data was input to the machine learning model. The colored image data was generated by lining up three types of colored images, namely, a colored image of only a board, a colored image of the board on which only solder is mounted, and a colored image of the board on which the solder and a part are mounted, similarly to the colored image data in Example 1. In the colored image data in Comparative Example 3, a color of a resist and a color of a pad were reversed with those in the colored image data in Example 1. That is, in the colored image data in Comparative Example 3, the pad was colored in green, and the resist was colored in orange. Thus, in the colored image data in Comparative Example 3, some of the components, namely, the pad and the resist, were colored in a color different from the color information.

As shown in FIG. 8, an accuracy of the output result from the machine learning model relative to the inspection result of the actually performed inspection was 100% in Example 1. On the other hand, the accuracies in Comparative Example 1, Comparative Example 2, and Comparative Example 3 were 60%, 80%, and 60%, respectively. Accordingly, the accuracies were equal to or less than 80% in all of Comparative Examples 1-3.

Through the above-described verification, it has been demonstrated that, by inputting image data in which a color corresponding to color information is applied to each component as image data based on pre-reflow images, a post-reflow inspection result is output from the machine learning model with high precision. Accordingly, it has been demonstrated that, by inputting input image data generated as described in the embodiment, etc. to the machine learning model, an inspection result of a post-reflow inspection in the case where products are manufactured based on a design shown in design information is determined with high precision.

According to at least one embodiment or example, input image data showing a pre-reflow state is generated based on soldering-related design information, and a color or a pattern corresponding to color information set for each type of component in the input image data is applied to each of the plurality of types of components. By inputting the input image data to the machine learning model using a machine learning model configured to output an inspection result of a post-reflow inspection in response to inputting of image data that is based on a pre-reflow image, appropriateness of a design shown in design information is determined. It is thereby possible to provide an information processing apparatus and an information processing method capable of determining appropriateness of soldering-related designs with high precision at a design stage prior to a start of manufacturing.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus relating to soldering of a part onto a substrate, comprising:
an image generation unit configured to generate input image data showing a pre-reflow state based on soldering-related design information, and to apply a color or a pattern corresponding to color information set for each of a plurality of types of components shown in the input image data to each of the plurality of types of components based on the color information; and
a determination unit configured to determine appropriateness of a design shown in the design information using a machine learning model configured to output an inspection result of a post-reflow inspection in response to inputting of image data that is based on a pre-reflow image by inputting, to the machine learning model, the input image data in which the color or the pattern corresponding to the color information is applied to each of the plurality of types of components.

2. The information processing apparatus according to claim 1, further comprising:
a cause identification unit configured, if the inspection result of the post-reflow inspection output from the machine learning model in response to the inputting of the input image data to the machine learning model indicates defectiveness, to identify a cause of the defectiveness indicated by the inspection result in at least one of: the input image data; the design information used in generating the input image data; and data generated in a process of generating the input image data from the design information.

3. The information processing apparatus according to claim 1, further comprising:
a color information setting unit configured to set the color information for each of the plurality of types of components so that the plurality of types of components are distinguished from one another by the color information, and that each of the plurality of types of components is identified by the color information.

4. The information processing apparatus according to claim 1, wherein
the image generation unit generates an outline element of each of the plurality of types of components based on at least the soldering-related design information, and
the image generation unit applies, in generating of the input image data, the color or the pattern corresponding to the color information set for each of the plurality of types of components to the generated outline element.

5. The information processing apparatus according to claim 4, wherein
the image generation unit generates the input image data using, as the soldering-related design information, design information of the substrate, design information of a metal mask used in mounting of solder onto the substrate, and design information of the part, and
the image generation unit generates the outline element of each of the plurality of types of components in such a manner that an outline element of each of one or more types of components configuring the substrate is generated based on at least the design information of the substrate, an outline element of the solder is generated based on at least the design information of the metal mask, and an outline element of the part is generated based on at least the design information of the part.

6. The information processing apparatus according to claim 5, wherein
the image generation unit generates the outline element of the solder based on relationship data indicating a relationship between an opening of the metal mask and a shape of the solder mounted on the substrate, in addition to the design information of the metal mask.

7. The information processing apparatus according to claim 1, wherein the image generation unit generates, as an image showing the pre-reflow state in the input image data, more than one of three types of images including: an image of only the substrate; an image of the substrate on which only solder is mounted; and an image of the substrate on which the solder and the part are mounted.

8. The information processing apparatus according to claim 1, further comprising:
a learning model generation unit configured to train a model through deep learning using learning data in which image data that is based on an image showing a pre-reflow state is associated with an inspection result of a post-reflow inspection that has been actually performed.

9. An information processing method relating to soldering of a part onto a substrate, comprising:
generating input image data showing a pre-reflow state based on soldering-related design information, and applying a color or a pattern corresponding to color information set for each of a plurality of types of components shown in the input image data to each of the plurality of types of components based on the color information; and
determining appropriateness of a design shown in the design information using a machine learning model configured to output an inspection result of a post-reflow inspection in response to inputting of image data that is based on a pre-reflow image by inputting, to the machine learning model, the input image data in which the color or the pattern corresponding to the color information is applied to each of the plurality of types of components.
